(19) United States
(12) Patent Application Publication
(10) Pub. No.: US 2024/0288586 A1
(43) Pub. Date: Aug. 29, 2024

(54) Multipath Suppression Device and Multipath Suppression Method

(71) Applicant: MITSUBISHI ELECTRIC CORPORATION, Tokyo (JP)

(72) Inventors: Tsubasa TERADA, Tokyo (JP); Yoshiki TAKAHASHI, Tokyo (JP); Ryuhei TAKAHASHI, Tokyo (JP)

(73) Assignee: MITSUBISHI ELECTRIC CORPORATION, Tokyo (JP)

(21) Appl. No.: 18/389,003

(22) Filed: Nov. 13, 2023

Related U.S. Application Data
(63) Continuation of application No. PCT/JP2021/025110, filed on Jul. 2, 2021.

(51) Int. Cl. G01S 19/22; G01S 19/37

(52) U.S. Cl. CPC G01S 19/22; G01S 19/37

(57) ABSTRACT

A multipath suppression device includes: a multipath signal reproducing unit including a correlation operation unit to divide a sampling signal of each of a plurality of received incoming waves by a length of a replica signal to generate a plurality of segments, and perform a correlation operation between each of the generated plurality of segments and the replica signal to acquire a result of the correlation operation, the multipath signal reproducing unit to estimate specifications of a reflected wave from a result of the correlation operation for the number of divisions, and reproduce a multipath signal using the estimated specifications; and a multipath suppression unit to subtract the multipath signal from the sampling signal to acquire a multipath suppression signal.

### CROSS REFERENCE TO RELATED APPLICATIONS

This application is a Continuation of PCT International Application No. PCT/JP2021/025110 filed on Jul. 2, 2021, which is hereby expressly incorporated by reference into the present application.

### TECHNICAL FIELD

The present disclosure relates to a multipath suppression technique.

### BACKGROUND ART

There is a positioning device such as a global navigation satellite system (GNSS) receiver that positions a receiver by receiving radio waves from a plurality of transmitters and obtaining a distance between each of the transmitters and the receiver from an arrival time difference of the received radio waves. The arrival time from each transmitter can be estimated from a peak position of a correlation operation between a received signal and a replica signal. In order to avoid an increase in an operation amount due to a convolution operation performed in the correlation operation, a general GNSS receiver prepares a plurality of time periods of correlator outputs each of which is multiplication result of a received signal and a replica signal to which a specific delay time is given, and estimates a peak position having a strong correlation from a relationship between values of the respective outputs. In such a GNSS receiver, when there is a reflected wave in addition to a direct wave in a multipath environment, there is a problem that a correlation operation result or a correlator output of a received signal is distorted, and thus an error occurs in an arrival time difference to be estimated and a positioning result. As for a technique for solving this problem, there is a narrow correlator described in Non-Patent Literature 1. In the narrow correlator, a correlator interval is set to be smaller than 1.0 chip, and an influence of a reflected wave having a delay amount equal to or larger than the correlator interval is reduced.

### CITATION LIST

### Non-Patent Literature

Non-Patent Literature 1: Van Dierendonck, A. J., Fenton, Pat, Ford, Tom, “THEORY AND PERFORMANCE OF NARROW CORRELATOR SPACING IN A GPS RECEIVER”, NAVIGATION, Journal of The Institute of Navigation, Vol. 39, No. 3, Fall 1992, pp. 265-284.

### SUMMARY OF INVENTION

### Technical Problem

The narrow correlator described in Non-Patent Literature 1 can suppress a reflected wave having a delay amount equal to or more than the correlator interval, but has a problem that a reflected wave having a delay amount less than the correlator interval cannot be suppressed.

The present disclosure solves the above problem, and an object of the present disclosure is to provide a multipath suppression technique capable of suppressing a reflected wave having a small delay amount that cannot be suppressed by a narrow correlator.

### Solution to Problem

A multipath suppression device according to an embodiment of the present disclosure includes: multipath signal reproducing circuitry including correlation operation circuitry to divide a sampling signal of each of a plurality of received incoming waves by a length of a replica signal and generate a plurality of segments, and perform a correlation operation between each of the generated plurality of segments and the replica signal and acquire a result of the correlation operation, the multipath signal reproducing circuitry to estimate specifications of a reflected wave from a result of the correlation operation for the number of divisions, and reproduce a multipath signal using the estimated specifications; and multipath suppression circuitry to subtract the multipath signal from the sampling signal and acquire a multipath suppression signal.

### Advantageous Effects of Invention

According to the multipath suppression device according to the embodiment of the present disclosure, it is possible to suppress a reflected wave having a small delay amount that cannot be suppressed by a narrow correlator.

### BRIEF DESCRIPTION OF DRAWINGS

FIG. 1 is a block diagram illustrating a schematic configuration of a multipath suppression device.

FIG. 2A is a schematic diagram of a situation in which multipath waves having different Doppler frequencies arrive, and FIG. 2B is a diagram illustrating a coordinate system.

FIG. 3 is a block diagram illustrating a configuration of a multipath signal reproducing unit.

FIG. 4A is a diagram illustrating a hardware configuration example of the multipath suppression device.

FIG. 4B is a diagram illustrating a hardware configuration example of the multipath suppression device.

FIG. 5 is a flowchart illustrating a multipath signal suppression method.

FIG. 6 is a flowchart illustrating multipath signal reproduction processing.

FIG. 7 is a graph illustrating an example of delay-Doppler data in a case where a reflected wave having a different Doppler is superimposed on a reception signal.

FIG. 8 is a graph illustrating an example of delay-Doppler data when multipath suppression of the present disclosure is performed in a case where a reflected wave having a different Doppler is superimposed on a reception signal.

FIG. 9 is a graph illustrating a simulation result of a pseudo distance estimation error before and after multipath suppression of the present disclosure is performed.

FIG. 10 is a table illustrating specifications of a multipath suppression method used for the simulation of FIG. 9.

### DESCRIPTION OF EMBODIMENTS

Hereinafter, various embodiments of the present disclosure will be described in detail with reference to the accompanying drawings. Note that components denoted by the same or similar reference numerals in the drawings have the same or similar configurations or functions, and redundant description of such components will be omitted.

### First Embodiment

### <Configuration>

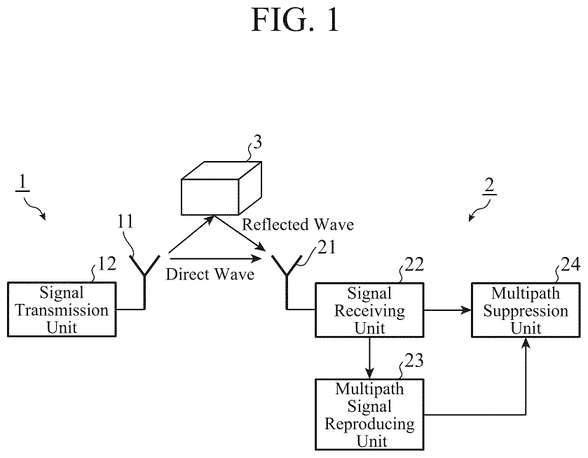

A configuration of a multipath suppression device according to a first embodiment of the present disclosure will be described with reference to FIGS. 1 to 4B. FIG. 1 is a block diagram illustrating a schematic configuration of a multipath suppression device 2. As shown in FIG. 1, a transmitter 1 includes a signal transmission unit 12 and a transmission antenna 11. The signal transmission unit 12 radiates a radio wave into space via the transmission antenna 11. The radiated radio wave reaches a reception antenna 21 connected to the multipath suppression device 2 via a propagation path. The multipath suppression device 2 includes a signal receiving unit 22, a multipath signal reproducing unit 23, and a multipath suppression unit 24. In general, the incoming wave may include a direct wave that directly arrives and a plurality of reflected waves that are reflected by a plurality of reflectors and arrive delayed from the direct wave. For the sake of brevity, FIG. 1 illustrates a case where there is one reflector 3 as a reflector and only one reflected wave is included in an incoming wave.

### (Signal Receiving Unit)

The signal receiving unit 22 samples an incoming wave received via the reception antenna 21 by A/D conversion to generate a sampling signal, and supplies the sampling signal to the multipath signal reproducing unit 23 and the multipath suppression unit 24.

### (Multipath Signal Reproducing Unit)

The multipath signal reproducing unit 23 estimates the specifications of the reflected wave from the sampling signal, reproduces a multipath signal that is a signal including only the reflected wave component using the estimated specifications, and supplies the reproduced multipath signal to the multipath suppression unit 24.

### (Multipath Suppression Unit)

The multipath suppression unit 24 subtracts the multipath signal from the sampling signal to suppress the influence of the multipath.

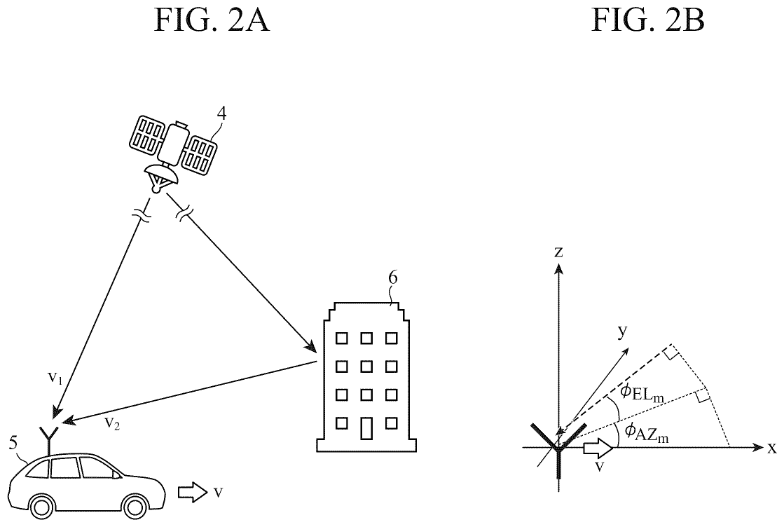

Here, a principle in which the multipath signal is reproduced by the multipath signal reproducing unit 23 will be described with reference to FIG. 2. When the transmitter 1 is a GNSS satellite, the sampling signal output from the signal receiving unit 22 is expressed by the following Equation (1).

$$x ( n ) = {\sum }_{m = 1}^{M} {α}_{m} {e}^{j ( 2 π Δ {f}_{m} nT + {θ}_{m} )} {e}^{j γ ( nT - {τ}_{m} )} s ( nT - {τ}_{m} ) + ϵ ( nT ) \qquad ( 1 )$$

where x(·) is a baseband signal acquired at the sampling interval T[s], and n is a sample number. M incoming waves are incident on the signal receiving unit 22, and a signal corresponding to m=1 is a direct wave. If the reflected wave components of m=2, . . . , M can be suppressed, the positioning accuracy is improved. The amplitude, the initial phase, and the code delay amount of each of the incoming waves are αₘ, θₘ[rad], and τₘ[s]. In addition, Δfₘ[Hz] represents a frequency error, and ε(·) represents noise. s(·) represents a waveform of the transmission signal, and in a case where the signal transmitted from the GNSS satellite is CDMA modulation, the transmission signal is code-modulated at a chip rate of a constant cycle. For example, the code specification of the L1C/A signal of the GPS is 1.023 Mops in a cycle of 1 ms. γ(t) corresponds to a transmission data bit. For example, in the case of the L1C/A signal, the value is switched to 0 or π at intervals of 20 ms depending on the bit string to be transmitted.

Here, a situation in which the reception antenna 21 connected to the signal receiving unit 22 is moving is considered. When the reception antenna 21 is moving, the incoming wave is affected by the Doppler effect. In particular, when the arrival angles of the direct wave and the reflected wave are different, a Doppler frequency difference occurs between the two waves. For example, as illustrated in FIG. 2A, a model in which two waves of a direct wave and a reflected wave arrive is considered. Here, a mobile object is traveling at a speed of v [m/s] in the x-axis direction, and a speed of v in the direct wave arrival direction is v₁ [m/s], and a speed of v in the reflected wave arrival direction is v₂ [m/s]. The Doppler frequency difference Δ_{fd2-1} [Hz] of the incoming wave in this situation can be expressed by Equation (2).

$$Δ {f}_{{d}_{2 - 1}} = {f}_{{d}_{2}} - {f}_{{d}_{1}} = \frac{{v}_{2} - {v}_{1}}{λ} \qquad ( 2 )$$

Here, λ is a wavelength of the transmission signal, and is a value in consideration of a Doppler caused by satellite motion. In addition, the coordinate system of the m-th incoming wave is defined in FIG. 2B, and when the azimuth angle and the elevation angle of each of the incoming waves are φ_{AZm}[rad] and φ_{ELm}[rad], respectively, the speed vₘ[m/s] is expressed by the following Equation (3).

vₘ=v cos(ϕ_{AZ}_{ₘ})cos(ϕ_{EL}_{ₘ}) (3)

As described above, when the GNSS receiver is moving, a Doppler frequency difference occurs depending on the moving speed and the angular difference between the direct wave and the reflected wave. The multipath signal reproducing unit 23 reproduces a multipath signal including a reflected wave by focusing on the Doppler frequency. When the reproduced multipath signal is x_{MP} hat (n), the multipath suppression unit 24 subtracts the multipath signal from the sampling signal to cancel the influence of the reflected wave as in the following Equation (4).

$$\tilde{x} ( n ) = x ( n ) - {\hat{x}}_{MP} ( n ) \qquad ( 4 )$$

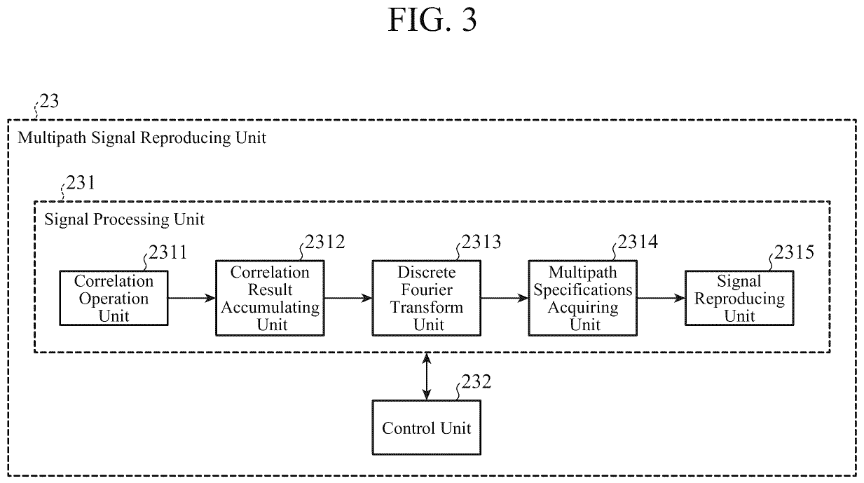

Next, a configuration of the multipath signal reproducing unit 23 will be described with reference to FIG. 3. FIG. 3 is a block diagram illustrating a configuration of the multipath signal reproducing unit 23. As illustrated in FIG. 3, the multipath signal reproducing unit 23 includes a signal processing unit 231 and a control unit 232. As an example, the signal processing unit 231 includes a correlation operation unit 2311, a correlation result accumulating unit 2312, a discrete Fourier transform unit 2313, a multipath specifications acquiring unit 2314, and a signal reproducing unit 2315. The correlation result accumulating unit 2312 may be implemented by a memory (not illustrated) or a memory 100d to be described later, and may be provided as an external element of the signal processing unit 231. The control unit 232 controls the operation of the signal processing unit 231.

### (Correlation Operation Unit)

The correlation operation unit 2311 divides the sampling signal by the replica signal length to generate a plurality of segments, and performs a correlation operation between each of the generated plurality of segments and the replica signal. When the number of divisions is N_{CINT}, the total correlation time to be accumulated T_{CINT}[s] is T_{CINT}=N_{CINT}·10⁻³ in the case of the LIC/A signal.

The correlation rₖ(τ) between the k-th (k=0, . . . , N_{CINT}−1) segment and the replica signal can be expressed by the following Equation (5) when the number of samples to be correlated is N_{fast} and the sample delay of the replica signal is τ.

$${r}_{k} ( τ ) = \frac{1}{{N}_{fast}} {\sum }_{n = 0}^{{N}_{fast} - 1} x ( n - {N}_{fast} k ) {s}^{*} ( ( n + {N}_{fast} k ) T - τ ) \qquad ( 5 )$$

A general GNSS receiver prepares correlator outputs (each of which is a multiplication result of a received signal and a replica signal to which a specific delay time is given) for a plurality of time periods, and estimates a correlation peak position from a relationship between values of the respective outputs. The delay time of a general replica is 0.5 chip ahead, no delay, and 0.5 chip delay, and correlator outputs each of which is a correlation result with a received signal are denoted as Early, Prompt, and Late, respectively.

In the case of the narrow correlator, the values of τ of Early, Prompt, and Late can be expressed as −μ/f_{c}, 0, and μ/f_{c}[s], respectively. Here, μ[chip] is an interval between the correlators, and f_{c}[chip/s] is a code frequency of the replica signal. Hereinafter, also in the present disclosure, description will be made using three correlator outputs of Early, Prompt, and Late, but similar processing can be performed even when the number of correlators is four or more.

The correlation operation unit 2311 supplies rₖ(τ) which is a result of the correlation operation, to the correlation result accumulating unit 2312.

The correlation result accumulating unit 2312 accumulates the individual correlation results rₖ(τ) for N_{CINT}. Here, in the individual correlation results, the phase of each of the correlator outputs is rotated by 0 or π [rad] depending on the transmission symbol. In order to avoid loss in subsequent processing, the correlator output is multiplied by −1 when the phase is inverted. As a result, a value obtained by canceling the corresponding phase inversion is accumulated. Examples of the method for determining whether the phase is inverted include a method in which a transmission signal uses a known pilot signal and a method using positive and negative values of a Prompt value.

The discrete Fourier transform unit 2313 performs discrete Fourier transform on the accumulated correlation results in the direction in which the division is performed to acquire delay-Doppler data. By this processing, the feature of the Doppler frequency of each correlator can be acquired. The reflected wave having a Doppler frequency different from that of the direct wave can be expected to be separated in the Doppler frequency direction. Note that the discrete Fourier transform unit 2313 may perform the discrete Fourier transform on the result of the correlation operation having a negative value in a direction in which the division is performed after the negative value is inverted to a positive value. Assuming that delay-Doppler data obtained by performing discrete Fourier transform on the accumulated correlation results is ρ(τ, f_{d}), ρ(τ, f_{d}) can be expressed as the following Equation (6).

$$ρ ( τ , {f}_{d} ) = \frac{1}{{N}_{CINT}} {\sum }_{k = 0}^{{N}_{CINT} - 1} {r}_{k} ( τ ) {e}^{- j 2 π {f}_{d} {kT}_{fast}} \qquad ( 6 )$$

Here, the Doppler frequency is f_{d}. Furthermore, the time length T_{fast} to be correlated is T_{fast}=N_{fast}·T.

The multipath specifications acquiring unit 2314 estimates the specifications of an incoming wave from the peak of the acquired delay-Doppler data, determines whether or not the incoming wave is a reflected wave from the estimated specifications, and acquires the specifications of the incoming wave determined to be the reflected wave.

The detection of the peak is performed by detecting a peak exceeding a threshold among peaks of the delay-Doppler data. Examples of a method of setting the threshold include a method of setting to a value obtained by multiplying noise floor power by a certain coefficient and a method of setting to a value obtained by multiplying an average value around a target cell excluding a guard cell by a certain coefficient on a principle similar to a constant false-alarm rate (CFAR).

The number of peaks exceeding the threshold is defined as M hat, and when M hat ≥2, it is considered that a reflected wave is included in an incoming wave, and thus, specifications of the incoming wave are acquired (estimated). The acquired specifications are a Doppler frequency f_{dm} hat[Hz], a delay time τₘ hat[s], an amplitude αₘ hat, and an initial phase θₘ hat[rad]. Here, m=1, . . . , M hat. The f_{dm} hat is acquired from the value of the peak position of the delay-Doppler data, and other estimation parameters are obtained by the following Equations (7) to (9).

$${\hat{τ}}_{m} = \frac{ρ ( μ / {f}_{c} , {\hat{f}}_{{d}_{m}} ) - ρ ( - μ / {f}_{c} . {\hat{f}}_{{d}_{m}} )}{ρ ( μ / {f}_{c} , {\hat{f}}_{{d}_{m}} ) + ρ ( - μ / {f}_{c} . {\hat{f}}_{{d}_{m}} )} ( 1 - μ ) \cdot \frac{1}{{f}_{c}} \qquad ( 7 )$$

$${\hat{α}}_{m} = \sqrt{{\vert ρ ( {\hat{τ}}_{m} , {\hat{f}}_{{d}_{m}} ) \vert}^{2} - {\hat{σ}}^{2}} \qquad ( 8 )$$

$${\hat{θ}}_{m} = angle ( ρ ( {\hat{τ}}_{m} , {\hat{f}}_{{d}_{m}} ) ) - 2 π {\hat{f}}_{{d}_{m}} \cdot \frac{{T}_{fast}}{2} \qquad ( 9 )$$

Note that, the estimated noise power is σ-hat². The σ-hat² is acquired from, for example, a value at a position away from the peak of the delay-Doppler data. In addition, the angle(·) represents processing of acquiring a phase angle.

Whether the incoming wave is a direct wave or a reflected wave is determined by, for example, the following method.
Method 1) Determine an incoming wave with m having the smallest τₘ hat, as a direct wave.
Method 2) Determine an incoming wave with m having the largest αₘ hat, as a direct wave.

In other words, the method 1 is a method of estimating the delay time τₘ hat of each incoming wave and determining an incoming wave other than an incoming wave having the shortest estimated delay time τₘ hat as a reflected wave. The method 1 is based on a feature that a reflected wave has a delay time equal to or longer than a direct wave, and when the method 1 is used in a case of a small amplitude difference, determination accuracy is increased.

In other words, the method 2 is a method of estimating the amplitude am hat of each incoming wave and determining an incoming wave other than an incoming wave having the largest value of the estimated amplitude am hat as a reflected wave. The method 2 is based on a feature that the level of the reflected wave is lower than that of the direct wave, and when the method 2 is used in a case of a small delay time difference, determination accuracy is increased.

The signal reproducing unit 2315 reproduces the multipath signal from the specifications of the reflected wave. That is, the signal reproducing unit 2315 reproduces the multipath signal for the signal determined as the reflected wave. For reproduction of the multipath signal, a parameter estimated by a functional unit such as the multipath specifications acquiring unit 2314 is used. The multipath signal x_{MP} hat(n) after reproduction can be expressed by the following Equation (10).

$${\hat{x}}_{MP} ( n ) = {{\sum }_{m = 1}^{\hat{M}}}_{m \neq {\hat{m}}_{o}} {\hat{α}}_{m} {e}^{j ( 2 π {f}_{{d}_{m}} nT + {\hat{θ}}_{m} )} {e}^{j \hat{γ} ( nT - {\hat{τ}}_{m} )} s ( nT - {\hat{τ}}_{m} ) \qquad ( 10 )$$

Here, m₀ hat is m corresponding to a direct wave, and γ hat(t) corresponds to a determination result of phase inversion determined by the correlation result accumulating unit and has a value of 0 or π.

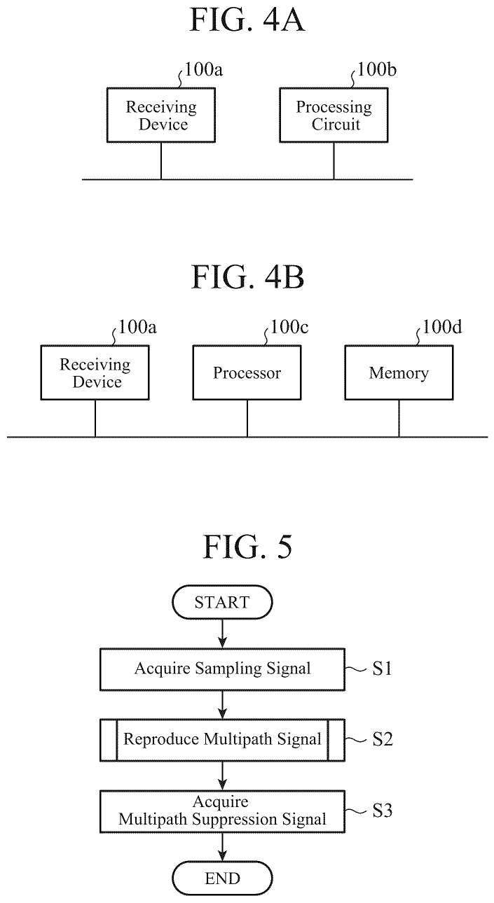

Next, a hardware configuration example of the multipath suppression device 2 will be described with reference to FIGS. 4A and 4B. As an example, as illustrated in FIG. 4A, the multipath suppression device 2 is implemented by a receiving device 100a and a processing circuit 100b. The signal receiving unit 22 is implemented by the receiving device 100a, and the multipath signal reproducing unit 23 and the multipath suppression unit 24 are implemented by the processing circuit 100b. The processing circuit 100b is, for example, a single circuit, a composite circuit, a programmed processor, a parallel programmed processor, an application specific integrated circuit (ASIC), a field-programmable gate array (FPGA), or a combination thereof. The multipath signal reproducing unit 23 and the multipath suppression unit 24 may be implemented by separate processing circuits, or may be implemented by one processing circuit.

As another example, as shown in FIG. 4B, the multipath suppression device 2 is implemented by a receiving device 100a, a processor 100c, and a memory 100d. The signal receiving unit 22 is implemented by the receiving device 100a, and the multipath signal reproducing unit 23 and the multipath suppression unit 24 are implemented by the processor 100c and the memory 100d. The functions of the multipath signal reproducing unit 23 and the multipath suppression unit 24 are implemented by the processor 100c reading and executing a program stored in the memory 100d. The program is implemented as software, firmware, or a combination of software and firmware. Examples of the memory 100d include a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disk, a compact disc, a mini disc, or a DVD.

### <Operation>

First, a multipath signal suppression method will be described with reference to FIG. 5. In step S1, the signal receiving unit 22 acquires a sampling signal from a plurality of incoming waves received via the reception antenna 21. The signal receiving unit 22 supplies the acquired sampling signal to the multipath signal reproducing unit 23 and the multipath suppression unit 24.

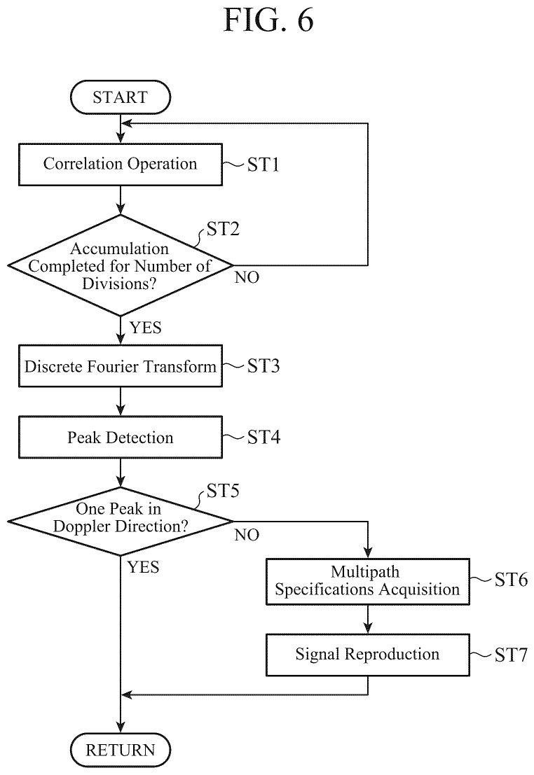

In step S2, the multipath signal reproducing unit 23 estimates the specifications of the reflected wave from the sampling signal supplied from the signal receiving unit 22 and reproduces the multipath signal including the reflected wave. The multipath signal reproducing unit 23 supplies the reproduced multipath signal to the multipath suppression unit 24. Note that details of the processing by the multipath signal reproducing unit 23 will be described later with reference to FIG. 6.

In step S3, the multipath suppression unit 24 subtracts the multipath signal supplied from the multipath signal reproducing unit 23 from the sampling signal supplied from the signal receiving unit 22 to acquire a multipath suppression signal in which multipath is suppressed.

Next, details of processing by the multipath signal reproducing unit 23 will be described with reference to FIG. 6. In step ST1, the correlation operation unit 2311 divides the sampling signal by the length of the replica signal to generate a plurality of segments, and performs correlation operation between each of the generated plurality of segments and the replica signal to acquire a result of the correlation operation. The acquired result of the correlation operation is accumulated by the correlation result accumulating unit 2312.

In step ST2, the control unit 232 determines whether or not the accumulation of the correlation result has been accumulated for the number of divisions. If the accumulation has not been completed for the number of divisions (No in step ST2), the processing returns to step ST1. If the accumulation has been completed for the number of divisions (Yes in step ST2), the processing proceeds to step ST3.

In step ST3, the discrete Fourier transform unit 2313 performs discrete Fourier transform on the accumulated correlation result in the division direction to acquire delay-Doppler data.

In step ST4, the multipath specifications acquiring unit 2314 detects at least one peak from the acquired delay-Doppler data.

In step ST5, the control unit 232 determines whether or not there is one peak obtained in the Doppler direction. In a case where there is one peak obtained in the Doppler direction (Yes in step ST5), the control unit 232 ends the processing. In this case, the multipath signal is empty or data having a value of 0. On the other hand, if there is not one peak obtained in the Doppler direction (No in step ST5), that is, if there are two or more peaks, the processing proceeds to step ST6.

In step ST6, the multipath specifications acquiring unit 2314 estimates the specifications of the incoming wave from the peak of the acquired delay-Doppler data, determines whether or not the incoming wave is a reflected wave from the estimated specifications, and acquires the specifications of the incoming wave determined to be a reflected wave.

In step ST7, the signal reproducing unit 2315 reproduces the multipath signal from the acquired specifications of the reflected wave, and the processing returns to the main routine in FIG. 5.

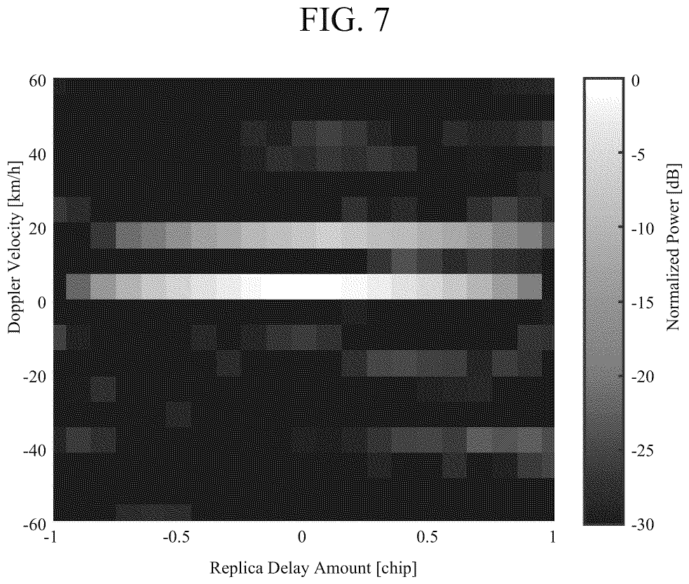

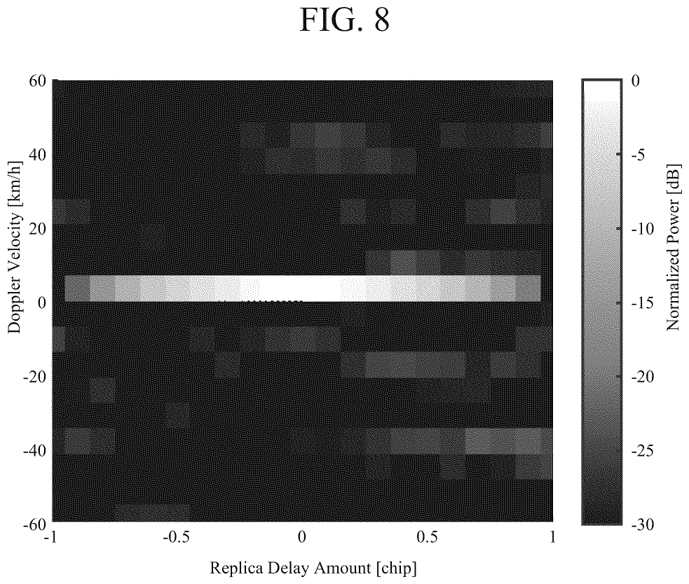

FIG. 7 is a graph illustrating an example of delay-Doppler data in a case where a reflected wave having a different Doppler is superimposed on the received signal. Furthermore, FIG. 8 is a graph illustrating an example of delay-Doppler data in a case where the multipath suppression of the present disclosure is performed in a case where a reflected wave having a different Doppler is superimposed on the received signal. In each drawing, the horizontal axis represents the delay amount of the replica signal, the vertical axis represents the Doppler velocity, and the shading represents the normalized power. In FIG. 7, there are peaks at the Doppler velocities of 0 km/h and 13.7 km/h, the peak at 0 km/h is a direct wave component, and the peak at 13.7 km/h is a reflected wave component. From FIG. 8, it can be confirmed that the reflected wave component is suppressed by performing the multipath suppression of the present disclosure, and the power at the position where the Doppler velocity is 13.7 km/h is reduced.

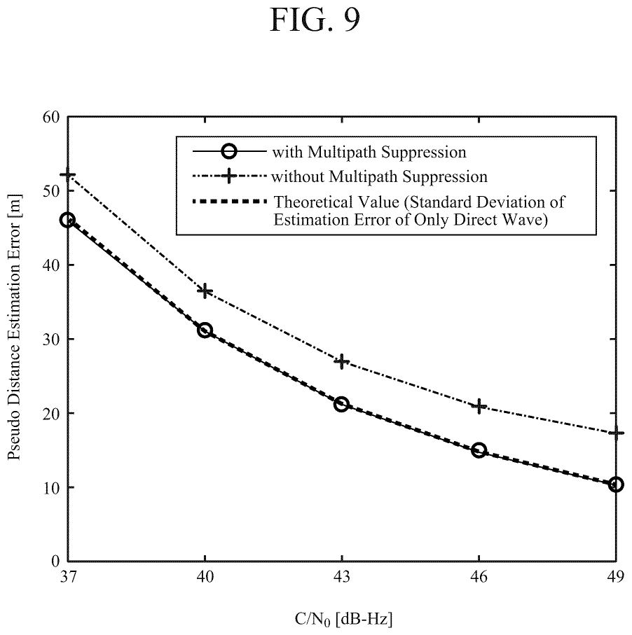

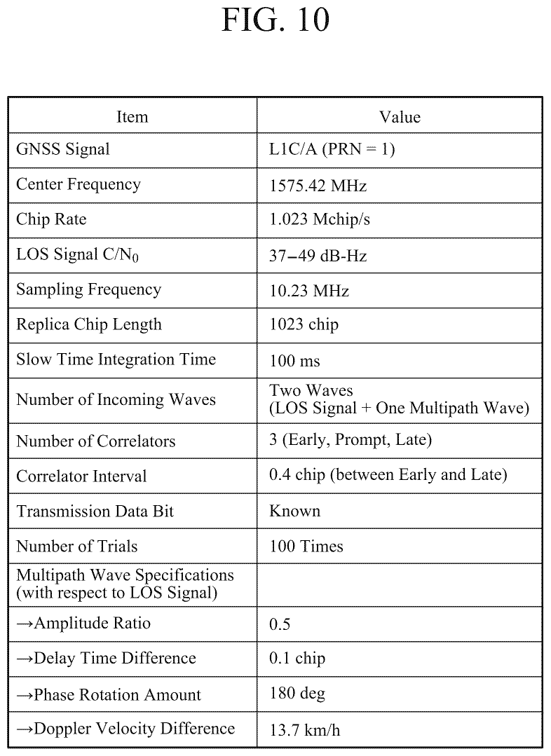

FIG. 9 is a graph illustrating a simulation result of the estimation error of the correlation peak position before and after the multipath suppression of the present disclosure is performed. In addition, FIG. 10 illustrates specifications of the multipath suppression method used for the simulation. In FIG. 9, the horizontal axis represents C/N₀[dB-Hz], and the vertical axis represents the pseudo distance estimation error[m]. Data with rounded markers indicate the results when the multipath suppression of the present disclosure is performed. Data with cross-shaped markers indicates a result when the multipath suppression of the present disclosure is not performed. The data with thick broken line indicates the theoretical value of the standard deviation of the pseudo distance estimation error of only the direct wave. Note that the correlator interval of each data is set to a narrow correlator of 0.4 chip, and the delay time of the multipath wave is set to 0.1 chip that cannot be suppressed by the conventional narrow correlator. From FIG. 9, it can be confirmed that by performing the multipath suppression of the present disclosure, multipath waves that cannot be suppressed by the conventional narrow correlator can be suppressed, and accuracy equivalent to a theoretical value of a standard deviation of a pseudo distance estimation error of only a direct wave can be achieved.

Note that the embodiments can be combined, and each of the embodiments can be appropriately modified or omitted.

### INDUSTRIAL APPLICABILITY

The multipath suppression technology of the present disclosure can be used to suppress a reflected wave that cannot be suppressed by a narrow correlator.

### REFERENCE SIGNS LIST

1: transmitter, 2: multipath suppression device, 3: reflector, 11: transmission antenna, 12: signal transmission unit, 21: reception antenna, 22: signal receiving unit, 23: multipath signal reproducing unit, 24: multipath suppression unit, 100a: reception device, 100b: processing circuit, 100c: processor, 100d: memory, 231: signal processing unit, 232: control unit, 2311: correlation operation unit, 2312: correlation result accumulating unit, 2313: discrete Fourier transform unit, 2314: multipath specifications acquiring unit, 2315: signal reproducing unit

1. A multipath suppression device comprising:
multipath signal reproducing circuitry including
correlation operation circuitry to divide a sampling signal of each of a plurality of received incoming waves by a length of a replica signal and generate a plurality of segments, and perform a correlation operation between each of the generated plurality of segments and the replica signal and acquire a result of the correlation operation,
the multipath signal reproducing circuitry to estimate specifications of a reflected wave from a result of the correlation operation for the number of divisions, and reproduce a multipath signal using the estimated specifications; and
multipath suppression circuitry to subtract the multipath signal from the sampling signal and acquire a multipath suppression signal.

2. The multipath suppression device according to claim 1, wherein
the multipath signal reproducing circuitry further includes:
discrete Fourier transform circuitry to perform discrete Fourier transform on the result of the correlation operation for the number of divisions, in a direction in which the division is performed, and acquire delay-Doppler data;
multipath specifications acquiring circuitry to estimate specifications of an incoming wave from a peak of the acquired delay-Doppler data, determine whether or not the incoming wave is a reflected wave from the estimated specifications, and acquire the specifications of the incoming wave determined to be the reflected wave; and
signal reproducing circuitry to reproduce the multipath signal from the acquired specifications.

3. The multipath suppression device according to claim 2, wherein
the discrete Fourier transform circuitry performs the discrete Fourier transform on a result of a correlation operation having a negative value, in the result of the correlation operation for the number of divisions, after inverting the negative value to a positive value, in the direction in which the division is performed, and acquire delay-Doppler data.

4. The multipath suppression device according to claim 2, wherein
the multipath specifications acquiring circuitry estimates a delay time of each of the incoming waves and determines an incoming wave other than an incoming wave having a shortest estimated delay time as a reflected wave.

5. The multipath suppression device according to claim 2, wherein
the multipath specifications acquiring circuitry estimates an amplitude of each of the incoming waves and determines an incoming wave other than an incoming wave having a largest value of the estimated amplitude as a reflected wave.

6. A multipath suppression method comprising:
dividing a sampling signal of each of a plurality of received incoming waves by a length of a replica signal and generating a plurality of segments, performing a correlation operation between each of the generated plurality of segments and the replica signal and acquiring a result of the correlation operation, estimating specifications of a reflected wave from a result of the correlation operation for the number of divisions, and reproducing a multipath signal using the estimated specifications; and
subtracting the multipath signal from the sampling signal and acquiring a multipath suppression signal.
